(19) United States
(12) Patent Application Publication
(10) Pub. No.: US 2016/0081864 A1
(43) Pub. Date: Mar. 24, 2016

(54) PORTABLE EXTRICATION DEVICE AND METHOD OF USE

(71) Applicant: Jason Bradbury, Jasonville, IN (US)

(72) Inventor: Jason Bradbury, Jasonville, IN (US)

(21) Appl. No.: 14/861,411

(22) Filed: Sep. 22, 2015

Related U.S. Application Data
(60) Provisional application No. 62/053,748, filed on Sep. 22, 2014.

(51) Int. Cl. A61G 3/06; A61G 3/02; B66B 9/187

(52) U.S. Cl. CPC A61G 3/063; B66B 9/187; A61G 3/0263

(57) ABSTRACT

A patient transport conveyor for conveying a patient on a liner between a first elevation and a second elevation includes a rail containing conveyor having a first end for placement at the first elevation and a second end for placement at the second elevation. The rail containing conveyor includes first and second spaced generally parallel rail members extending generally between the first and second ends. The first and second rail members define a litter receiving space for receiving the litter and maintaining the litter on the conveyor. A guide member extends generally between the first and second ends. The guide member configured for being engaged with the litter to help maintain the litter in the litter receiving space. A coupler is disposed at the first end and is configured for coupling the transport conveyor to an anchoring at the first elevation for maintaining the position of the transport conveyor.

### PRIORITY CLAIM

The instant application claims benefit of priority to U.S. Provisional Patent Application Number Ser. No. 62/0053,748 that was filed on Sep. 22, 2014, and which is fully incorporated herein by reference.

### TECHNICAL FIELD OF THE INVENTION

The present invention is a device for safely and efficiently extricating an incapacitated or injured person from a higher or lower elevation position and a method for use.

### BACKGROUND OF THE INVENTION

Mining, construction, and agricultural personnel use heavy equipment items such as dump trucks, cranes, earth movers, bull dozers, tractors, and combines to perform routine mining, construction, and agricultural related tasks. These large equipment items often require the operator to climb a set of stairs or ladders in order to ascend to the cab, or control center of the machinery item.

For example, on a Caterpillar model 793 the operator must ascend a staircase that is affixed to the vehicle in order to reach the cab. The height of the cab is approximate 15-20 feet above the ground. In an additional example, a typical John Deere Combine has an attached ladder that is affixed to the vehicle in order to reach the cab. The height of the cab on this vehicle is approximately 6-10 feet above the ground. There are many other examples of vehicles in which the operator is in an elevated position relative to the ground.

Alternatively, there may be situations in which an injured or incapacitated person must be safely and efficiently extricated from a position that is beneath the level of the rescuers. For example, during excavation operations, workers often need to perform tasks within an excavated pit. If it becomes necessary to extricate personnel from the pit, difficulties arise in safely and efficiently pulling the person up from the lower level.

Problems arise when persons who operate of one of these vehicles or are within such a pit must be safely removed from the vehicle or pit and lowered or raised to the ground for reasons such as injury, incapacitation, or other emergency situation.

Traditionally, emergency personnel have relied on extension ladders, ropes, pulleys, rescue baskets, and other various devices to aid in the extrication of the operator or personnel from different elevations. Unfortunately these devices are generally not well designed to accommodate this type of use, are used infrequently and inconsistently by rescue personnel. As such, these devices can be dangerous for both the injured operator and the emergency personnel attempting the rescue.

A number of challenges arise when lowering an injured person from an elevated position. First, the rate at which the person is lowered must be safely controlled. Additionally the path along which the patient is lowered also must be managed. Traditionally this has been accomplished by rigged up ropes, extension ladders, brute strength, and a bit of luck.

Typically a litter, which may comprise inter alia a cot, gurney, backboard, or “Stokes Basket” type of device is also used to aid in the extrication of the patient. The patient is strapped to the litter, pushed over the edge of the elevated platform, and lowered as gently as possible to the ground.

Numerous problems arise during such extrication. First, the extrication litter must be pushed past the break over point of the elevated platform. This process increases the risk of dropping the person in the basket to the ground, or accidently slamming them into a surface of whatever platform they are attempting to extricate the patient from. Additionally, this process generally requires the rescuers to lean over the edge of the platform, and place undue, unnecessary, and even dangerous loads on the rescuers and on their bodies, along with creating a condition conducive to causing the rescuer to fall off the platform.

When the rescue crew first pushes the litter with the attached injured person over the edge of the platform, there is a point at which the is commonly used to assist in such extrication operations. The “Stokes Basket” is basically a wire frame litter, with sides and straps to strap in patients for safety during transport. Stokes Baskets are available from a variety of sources such as EHS Clear of 2160 B, Oakland, Calif. 95131.

One object of the present invention is to provide a rescue transport device that enables a rescuer to safely move a litter-bound patient from a first location at a first elevation, to a second nearby location at a second elevation.

### SUMMARY OF THE INVENTION

In accordance with the present invention, a patient transport conveyor is provided for conveying a patient on a litter between a first elevation and a second elevation. The transport conveyor comprises a rail containing conveyor having a first end for placement at the first elevation and a second end for placement at the second elevation. The rail containing conveyor includes first and second spaced, generally parallel rail members that extend generally between the first and second end. The first and second rail members define a litter receiving space for receiving a litter and maintaining the litter on the conveyor. A guide member is provided that extends generally between the first and second ends. The guide member is configured for being engaged with the litter to help maintain the litter in the litter receiving space. A coupler is disposed at the first end and is configured for coupling the transport to an anchoring at the first elevation for maintaining the position of the transport conveyor.

In a preferred embodiment, the rail conveyor includes at least first conveyor module and a second conveyor module, with the first and second modules including mating members that are configured to mate the first and second modules together so that they are removably coupled to each other. A lock member can also be included that is removably coupled to the first and second module members, for locking the first and second module members together, to keep them separating.

In another preferred embodiment of the present invention, the first and second spaced parallel rail members are spaced sufficiently for defining a litter receiving space there between, and are elevated and positioned for engaging the side surfaces of the litter, for maintaining the litter in the litter receiving space between the first and second generally parallel rail members. The guide members can include a male guide member coupled to one of the rail conveyor and litter and a female guide member coupled to the other of the rail containing conveyor. The female guide member is configured for receiving the male guide member for guiding the litter between the first and second ends of the rail conveyor and maintaining the litter on the rail containing conveyor.

The conveyor can also include first and second leg members that are coupled to the rail containing conveyor. The first and second leg members have an axially variable length, wherein the length of the first leg member is axially variable independently of the length of the axial variability of the second leg member. First and second feet members can be pivotably coupled to the respective leg members, for more securely engaging the ground or other surface to which the foot members are set to engage.

Preferably, the patient transport conveyor has a coupler that comprises a jaw member that defines a jaw opening that is configured for receiving an anchoring. A lock member can be provided for closing the jaw opening that receives the anchoring, for thereby maintaining the anchoring within the jaw opening to prevent the conveyor and anchoring from becoming separated.

In a preferred embodiment of the present invention, the extrication device (patient transport conveyor) is comprised of multiple, modular sections such as an arcuate or radiused first section, one or more generally linear second or middle section, and a generally linear third or elevation engaging section. Additionally an optional additional support member may be used in some situations where additional height, weight handling capability, or stability is required. Each of the sections can be separated from each other for storage, and can be used as individual pieces, a combination of various sections, or as a total unit. The modularity of the extrication device allows it to be used on a wide range of platform types, and platform heights. A preferred embodiment is three sections, but more sections can be added, or removed depending on the needed height.

The arcuate member of the extrication system is designed to allow a smooth transition from the horizontal plane of transport of the patient litter to a vertical plane of transport for lowering. This maintains a safe position for the patient in the basket, minimizes the risk of dropping or flipping the basket, and makes the lowering process easier and safer to manage.

The Extrication device of the present invention contains a plurality of frame rails. Outer frame rails provide support and guidance for the patient transport basket, and inner frame rails provide support from the system and guidance for the patient transport basket.

Control is enhanced by the lower parallel frame rails that are used in the extrication system. The lower and inner parallel frame rails act as a guide for the patient transport basket as it is being raised or lowered with the system. The parallel center pipes are sized in such a way as to allow the center frame rails of the patient basket to fit between them. The function is similar to that of a slot car track as the rail of the basket is captured between the lower rails of the extrication device, and safely guided as the basket is raised and lowered.

The outer frame members of the extrication device are slightly wider than the patient litter and are elevated to engage the side of the litter. The outer rails prevent additional side to side movement of the basket and support for the system by capturing the basket in the space between the two outer rails to thereby prevent lateral movement. The outer frame members are also designed to minimize interference with the patient basket, and any ropes, straps, or other devices used to hold the patient on to the patient transport device and to raise or lower the patient with the system.

The extrication system frame is preferably buildable by joining together a plurality of modular sections having mating members that facilitate joinder of adjacent modular sections. The mating members include locking pins for locking the sections together to maintain the sections in a connected relation. The locking pins are fixedly attached to the frame members by flexible cable like tethers to prevent the pins from being misplaced, or dropped when adding or removing sections.

One feature of the present invention is that a coupling member is provided for fixedly coupling the top portion of the frame system to the hand rails or the platform for the equipment item. The majority of mining equipment with elevated platforms has some type of hand rail assembly along the perimeter of the elevated platform. A preferred embodiment of the present invention includes a locking mechanism on the upper section of the extrication system frame to quickly, and easily lock the upper member to a handrail on the platform from which the patient is being extricated for preventing the frame from becoming separated from the equipment hand rail during transport of the patient.

An additional feature of a preferred embodiment of the present invention is the employment of stabilizing feet and axially extendable lower leg portions on the lower portion of the lower frame section of the extrication system. The stabilizing feet act similarly to the stabilizing feet of an extension ladder and allow the system to stabilize itself on uneven terrain, or at varying angles. Depending on the number of sections used, the terrain, the height of the platform, and other factors, the lower most frame section may be not be at the same angle every time that it is used. The axially extendable legs and moveable stabilizing feet allow the system to be used in a wider variety of conditions and situations by enabling the user to adjust the conveyor to solidly engage the ground or uneven terrain. The feet pivot on an axis that allows the feet to move independently. The independent movement of each foot allows each foot to align itself with the ground in such a way so as to get the most amount of traction. For example, if the ground is inclined, the pivoting feet can angle themselves to match the slope of the ground and allow the device to be separately angled in the optimum position.

### BRIEF DESCRIPTION OF THE DRAWINGS

FIG. 1 is a side view of a heavy equipment item, here shown as a ver large mining dump truck of the type used in connection with heavy excavating and mining operations such as a Caterpillar, Model 793, to which the transport conveyor of the present invention is coupled;

FIG. 2 is a front view of the heavy equipment item, and transport conveyor of the present invention;

FIG. 3 is an exploded view of the primary modular components of the transport conveyor of the present invention;

FIG. 4 is a perspective view of a linear module of the present invention;

FIG. 5 is a top partial view of the first end of the linear module of FIG. 4;

FIG. 6 is a sectional view taken along lines 6-6 of FIG. 4;

FIG. 7 is a top partial view of the second end of the linear module of FIG. 4;

FIG. 8 is a perspective view of an arcuate module of the present invention;

FIG. 9 is a perspective view of a laterally extending “tic” component of the conveyor of the present invention;

FIG. 10 is a perspective view of a telescoping e member of the present invention;

FIG. 11 is a first progressive side view of the transport conveyor of the present invention coupled to a heavy equipment item, in a position wherein the litter is just placed upon the first end of the conveyor;

FIG. 12 is a view similar to FIG. 11 except showing the litter being lowered on the conveyor and being positioned about half way between the first and second ends;

FIG. 13 is a view similar to FIG. 12, except showing the litter fully lowered and adjacent to the second end of a conveyor of the present invention prior to pick up;

FIG. 14 is a side view of a litter used in connection with the present invention;

FIG. 15 sectional view of the litter of FIG. 14 being mounted upon the transport conveyor of the present invention;

FIG. 16 is a side, schematic view of a first embodiment coupler of the present invention;

FIG. 17 is a side, schematic view of a second embodiment coupler of the present invention in the jaw open position;

FIG. 18 is a side, schematic view of the coupler of FIG. 17 showing the coupler in the jaw closed position;

FIG. 19 is a side, schematic view of a third alternate embodiment coupler of the present invention;

FIG. 20 is a side, schematic view of a fourth embodiment coupler of the present invention;

FIG. 21 is a side, schematic view of a fifth alternate embodiment coupler of the present invention; and

FIG. 22 is a side view of the coupler of FIG. 21, showing the coupler in the jaw closed position.

### DETAILED DESCRIPTION

A patient transport conveyor is shown in the figures that is used for extrication from positions at a first elevation 18, such as the cab 66 of a mining vehicle such as a mining dump truck 12, or other type of vehicle, that has a location at a first elevation 18 from which the patient need to be removed from that is a second elevation 22 different than the first elevation 18.

Just as the first elevation 18 can be elevated relative to the second elevation 22 (the ground), the first elevation 18 can also be disposed below the second elevation 22, such as when the first elevation 18 is at the bottom of a pit or trench. Such elevational differences are quite common in all types of construction and building sites, including places such as mines, building sites, pits, trenches, excavations and the like.

The patient transport conveyor 10 is provided for transporting a patient P, and includes a bed portion usually upon which a patient can rest.

One example of such a litter 16, is the Stokes basket as described above. However, as used in this application, the term “litter” is designed to be construed broadly enough to include cots, gurney, backboards, braces, slings, hammocks, mattresses and other articles on which a patient can be placed. Although not shown, a litter could comprise something such as a vehicle seat or a wheel chair, and need not be a litter on which the user lays prone.

The primary component of the patient transport conveyor 10 is a rail containing conveyor 24 that includes a first end 28 that is preferably coupled to some anchoring at the first elevation 18 and a second end 30. The second end 30 is preferably disposed adjacent to the second elevation 22, which often comprises the ground or pavement of the particular area.

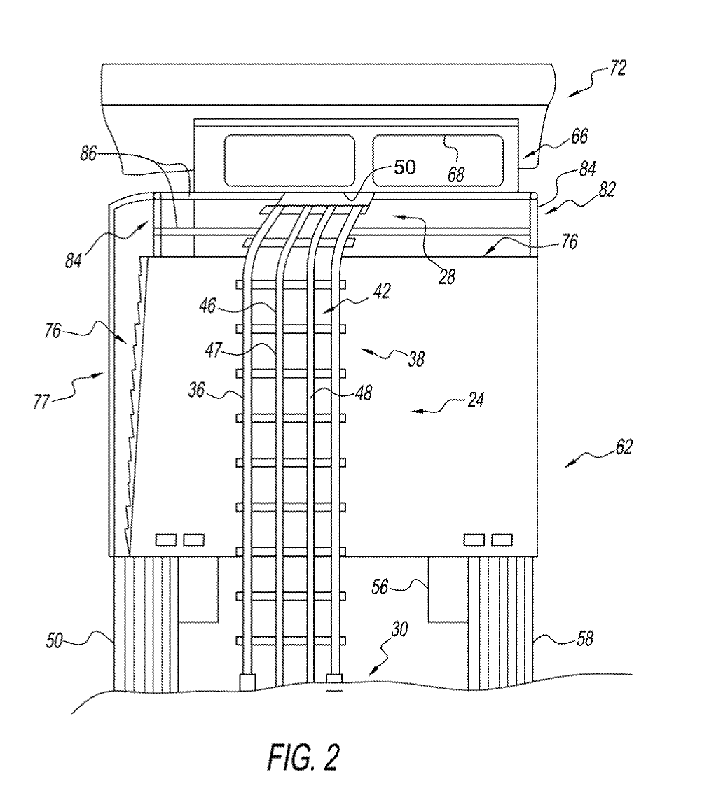

As best shown in FIG. 2, the rail containing conveyor 24 includes a first outer rail member 36 that is disposed in a spaced, generally parallel relation with a second outer rail member 38. The first and second outer rail members 36, 38 extend generally between the first end 28 and second end 30 of the rail containing conveyor 24, and are spaced at a constant, and appropriate distance to define there between a litter receiving space 42 for receiving the litter 16 and maintaining the litter 16 on the conveyor 24. A guide member 46 extends generally between the first and second ends 28, 30. The guide member 46 is configured for being engaged with the litter 16 to help maintain the litter 16 in the litter receiving space 42.

The guide member 46 can take a wide variety of forms, but generally includes a male or female member that is configured for matingly engaging the corresponding female or male member that is coupled to the litter 16, to help ensure not only that the litter 16 stays positioned within the litter receiving space 42 of the rail containing conveyor 24, but to also provide a track or guide to help ensure linear movement of the litter 16 between the first and second ends 28, 30, as the litter 16 travels along the rail containing conveyor 24. One can analogize the guide member system 46 to a slotted track that is found on toy slot car race sets, wherein the slot is configured for receiving a car-mounted stud or pin or fin type follower which is guided along its appropriate path through the engagement of the follower on the car with the slot in the track.

In the rail containing conveyor 24 shown in the figures, the guide member 34 preferably comprises a more closely spaced first and second guide rails 47, 48. The first and second guide rails 47, 48 are disposed at a spaced parallel relation, and generally extend between the first end 28 and the second end 30. The guide rail members 47, 48 are configured, spaced and positioned for receiving a follower, such as a fin, keel, single stud, or plurality of studs that are coupled to the litter basket 16 and extend downwardly therefrom to be placeable in the guide member receiving space 134 between the first and second guide rails 46, 47.

A coupler 50 is disposed at the first end 28 of the rail conveyor 24 and is provided for fixedly coupling the transport conveyor 10 to an anchoring member, such as a rail 86 at the first elevation 18. The coupler 50 maintains the position of the transport conveyor 10 on the anchor (here the hand rail 86 of the vehicle 12), and prevents the transport conveyor 10 from becoming dislodged from the vehicle 12.

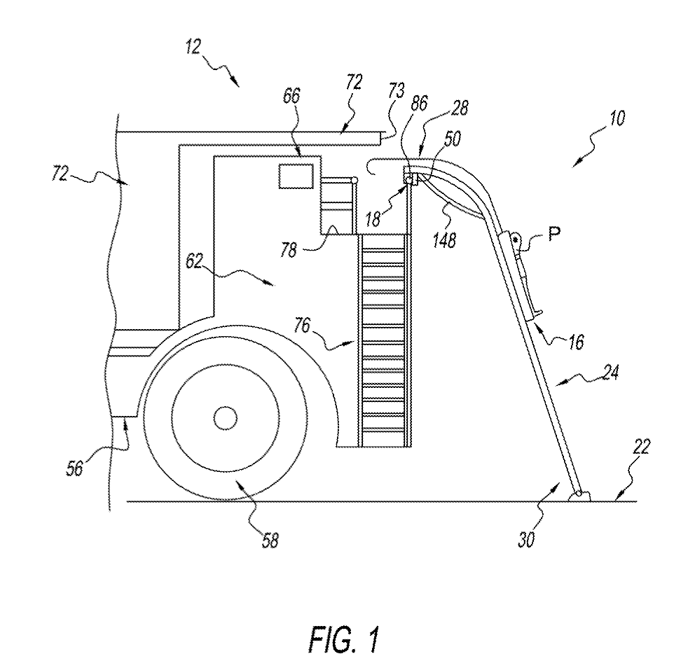

As discussed above, the patient transport conveyor 10 of the present invention has particular utility when used in connection with very large items of heavy equipment, such as the vehicle 12 that is shown in FIGS. 1 and 2. The vehicle 12 shown in FIGS. 1 and 2 can be a mining equipment device such as a Caterpillar Model 793D mining dump truck, or one of hundreds of other vehicles such as drag lines, earth movers, combines and the like that are large, and have a working area where workers are likely to be found that is at a first elevation 18 that is different than the elevation 22 such as the ground, to which the patient must normally be taken in order to be placed on a secondary transport such as a truck or ambulance.

The truck 12 includes a frame 56 for supporting the truck's 12 components and a plurality of ground engaging tires 58 that support the frame 45 above the ground. An engine compartment 62 is disposed at the front of the vehicle, and is provided for housing the propulsion components of the truck 12 that normally include a diesel engine and a transmission. Additionally, the vehicle 12 may be either an electrically operated vehicle, or a diesel-electric vehicle, such that the engine compartment would house electric motors and/or batteries to drive the electric motors, rather than or in addition to the diesel engine and transmission arrangement described above.

An operator station or cab 66 is disposed above the engine compartment, and includes a plurality of windows 68 through which a user working within the cab 66 can view the exterior environment in which the vehicle 12 exists. A dump bed 72 extends to the rear of the truck 12, and is generally disposed behind the cab 66 and engine compartments 62.

The dump bed 72 is configured for receiving large amounts of material, such as material that is mined, overlay material or the like. The dump bed 72 can include a reinforced canopy 73 that extends over the cab 66. The canopy 73 is provide for helping to shield the cab from debris, such as rocks and soil that are being dumped into the interior of the dump bed 22 during the normal material loading operation.

A ladder or stair set 76 having a hand rail 77 is provided for enabling the user to climb up from the ground to a cat walk 78 that is positioned at about the same level as the cab 66 and upon which the driver walks to enter the cab 66. As the cat walk 78 and cab 66 are elevated, a railing 82 that includes a plurality of vertical rail posts 84 that are connected by a plurality (here shown as two) lateral rails 86 are provided as a safety measure.

To give one an idea of the scale of such a machine, the Caterpillar 793D has tires 58 that have an outer diameter that is generally greater than the height of most people. The distance from the ground to the upper surface of the dump bed 72 is often about 20 feet which is referred to as the dump height. The distance from the ground to the top of the cab 66 is about 18 feet. As such, the cat walk 76 is probably about 10 to 14 feet off the ground 22, which is almost as high as the lowest point of a roof on a two-story house or building.

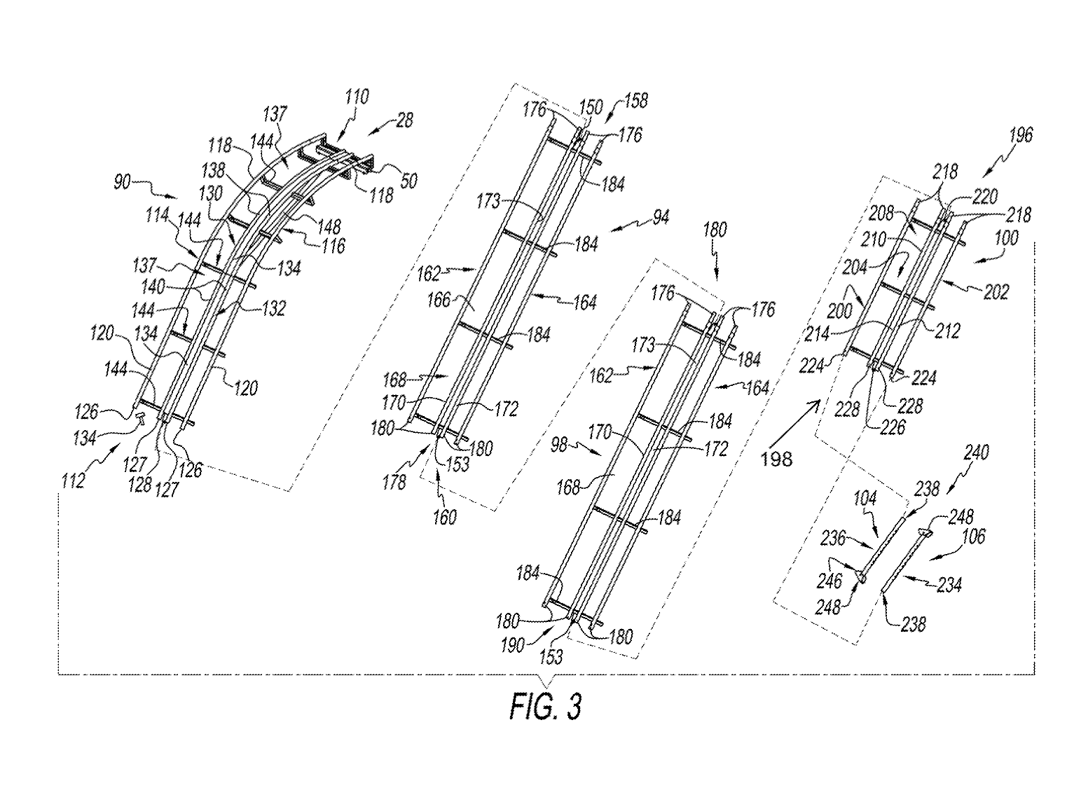

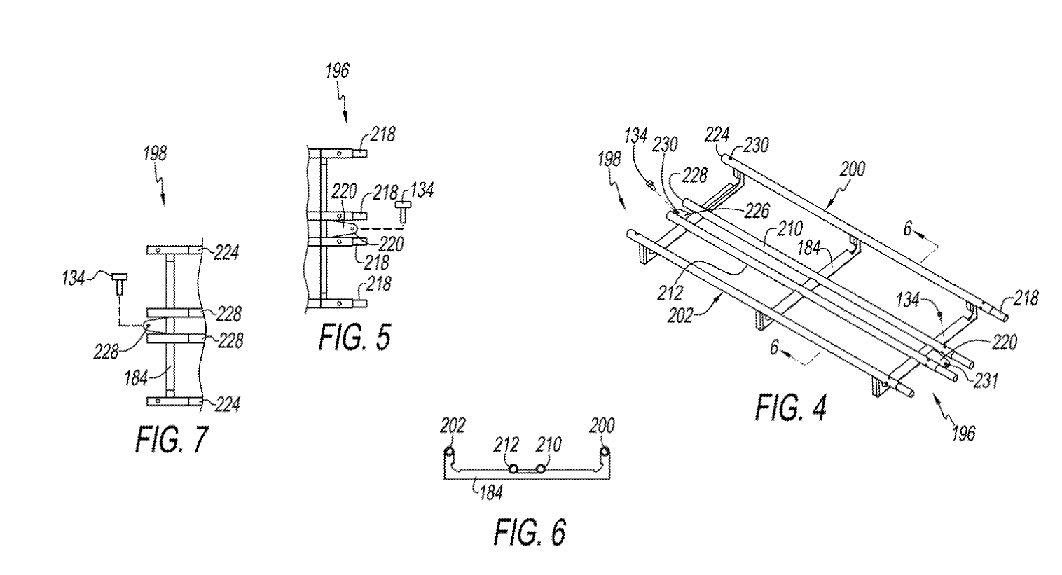

Turning now to FIGS. 3 and 4 in particular, the rail conveyor 24 of the present invention is preferably designed to be modular and is comprised of a variety of modular sections. The modularity of design has several spans are needed. For example, since the complete device comprises the assembly of a plurality of sections, the device an also be assembled with only two of the four sections shown in FIG. 3 for shorter distances between the first 18 and second 22 elevations, or all four sections shown in FIG. 3 for situations wherein the distance between the first 18 and second 22 elevations are great enough to require all four sections plus the telescopic legs and feet. As such, a single rail conveyor 22 can be used with the plurality of different equipment types.

For example, a rescue vehicle can be employed by a mine that is used by the mine to extricate workers from a wide variety of vehicles. In the case of an emergency, wherein a miner needs to be moved from a first 18 to a second 22 elevation, the rescue car can go to the particular machine or pit in which the injured miner is placed, and assemble the appropriate amount of sections of the device 24 for the particular devotional difference encountered, so that the conveyor 24 can be sized appropriately to help to extricate the miner from the particular predicament on a wide variety of situations and equipment types.

As best shown in FIG. 3, the conveyor 24 is made a plurality of modular sections including a first, arcuate module section 90, a second, generally linear modular section 94, a third, generally linear module section 98, and a fourth, reduced length, linear modular section 100. It will be appreciated that although four modular sections are shown in FIG. 3, the device can be designed with any number of modular sections that can be coupled together to form a patient conveyor 24 of an appropriate length.

In additional to the first through fourth modular sections, 90, 94, 98, 100, first and second leg members 104, 106 are provided that are telescopically engaged to the distal or second end of the lower most (here the fourth) linear modular section 100. The legs are telescopically received within, and independently axially movable within the appropriate modular section, 90, 94, 98, or 100, so that the user can vary the effective length of the modular section (and hence the conveyor 24) by axially adjusting the leg members to the appropriate length, so that the bottoms of the legs properly engage the ground 22.

The first arcuate modular sec on 90 has a first end 100 to which the coupler 50 is attached, and a second end 112. The modular section 90 is generally railroad track-like in configuration, and includes a first outer rail 114 and a second outer rail 116. The first and second outer rails 114, 116 extend in a generally longitudinal direction, and are disposed in a spaced parallel relation. In the first arcuate module section 90, the first and second outer rails 114, 116 include an arcuate portion 118 and a linear portion 120. The arcuate portion is provided, as best shown in FIG. 1, to provide a transition area between the first elevation 18 and that portion of the rail conveyor 24 that extends downwardly to the second elevation 22.

As such, as shown in FIG. 1, the user can place the user basket 16 containing the patient on the first end, adjacent coupler 50 in a generally horizontal orientation. As the litter 16 moves through the arcuate portion 118, the pitch of the litter 16 changes from a generally horizontal pitch to a “forward and down” somewhat angled-from-vertical pitch. The litter 16 then continues to move generally linearly along this angled vertical pitch until the basket reaches the second elevation 22 (or close thereto) at which point the litter is lifted by people out of its engagement with the conveyor 24. When so removed, the litter is generally held in a horizontal orientation, and then transported across the second elevation such as ground 22 to either a health care facility or a transport vehicle, such as an ambulance that can transport the patient P to an appropriate healthcare facility.

The first arcuate section 90 also includes a linear portion 120 that is disposed closer to the second end 112 of the first, arcuate modular section 90. The relative length of the arcuate and linear portions 118, 120 are variable by the user depending upon specific needs and desires.

A coupler is provided for enabling the arcuate section 28 to mate with an anchoring feature, such as the hand rail 86 of the vehicle. A mating member is provided to enable the second end 112 of first section 90 to mate with the first end 172 of the second section 94, and to an adjacent modular section. The second ends 160 are generally formed to have the same diameter as the diameter of the first and second outer rails 120, and include a hollow interior for receiving the reduced diameter mating member 176 of the corresponding male members of the second modular section 94.

A tongue member 128 having an aperture (not shown) that can receive a locking pin 134 is sized and configured for mating with a similar tongue member on the first end 158 of the second modular member 94. A tongue member 150 also includes an aperture that is sized and configured to align with the aperture of tongue member 128, so that the guide pin 134 can be passed through the apertures to lock and fixedly position the second end 112 of the first modular member 90 to the first end 158 of the first linear modular section 94.

The first arcuate modular section 90 also includes a guide portion that includes first and second guide rails 130, 132. The first and second guide rails 130, 132 are disposed in a spaced, parallel relation and extend generally parallel to each other. The arcuate curve of the first and second guide rails, 130, 132 corresponds generally to the arcuate curve of the arcuate portion 118 of first and second outer rails 114, 116. Additionally, the first and second guide rails 130, 132 also include a linear portion 140 that corresponds n position generally with the linear portion 120 of the outer rails 114, 116.

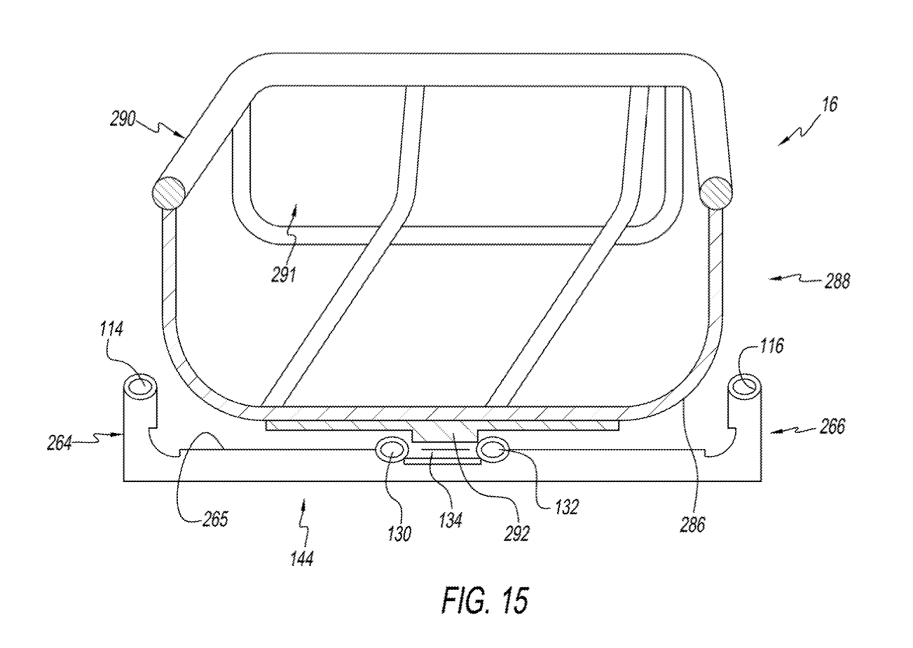

The first and second guide rails 130, 132 define a side space 134 there between, for receiving a male guide member such as a tongue, fin or stud 292 (FIG. 15) within the guide space 134. The inter-engagement between the male guide member 292 of the basket member 16 and the female guide space 134 helps to maintain the basket 16 within the litter receiving space 137 that is defined as the space between the first and second outer rails 114, 116.

The outer rails 114, 116 are spaced so that they have a width that is wide enough to receive the width of an appropriate litter 116. Additionally, the outer rails 114, 116 are relatively elevated to a position wherein they can engage the sides of a litter basket 16. By being able to engage the sides of the litter 16, the outer rails 114, 116 can help to keep the basket 16 positioned within the litter receiving space 137, and thereby prevent the litter 16 from moving laterally and falling off of the conveyor 24.

A plurality of laterally extending tie members 144 extend between the first and second outer rails 114, 116, and are coupled to the inner guide rails 130, 132, to maintain the appropriate position of the rails 114, 116, 130, 132, by providing an anchor to all of the rails, in much the same way that a tie of a railroad track maintains the appropriate spatial relation and fixed position of the first and second rails of the railroad track. A chordal support brace 148 extends generally along the under side surface of the first section 90 and extends generally between the first end of the arcuate portion 118, and the start of the linear portion 120 of the first arcuate section 90. The support brace 148 also helps to maintain the proper radius of curvature of the arcuate portion 118, and provides additional structural strength and rigidity to the first modular section 90.

The second generally linear conveyor rail section 94 includes a first end 158 that is matingly engageable with the second end 112 of the first modular section 90 and a second end 160. The second end 160 as will be described later, is provided for matingly engaging and being coupled to the first end 180 of the second linear module section 98.

The first linear modular section 94 includes first and second generally linear outer rail members 162, 164 that are sized and configured to be generally co-linear with the first and second outer rail members 114, 116 off the first arcuate conveyor section 90, when the first linear section 94 is assembled and coupled to the first arcuate section 90.

The first and second linear rails 162, 164 define a litter receiving space 166 there between. As discussed in connection with rails 114, 116, the first and second outer rails 162, 164 are separated by a distance that is slightly greater than the width of the litter 16 with which the device is intended to be used, so that the litter 16 can fit within the litter receiving space 166 comfortably and slide along the first and second rail sections 90, 94 on its path from the first elevation 18 to the second elevation 22.

Additionally, the first and second linear rails should be elevated relative to the bottom of the basket and the upper surface of the first and second guide rails 170, 172, so that the first and second side rails 162, 164 are positioned to engage the side surfaces of the litter member 16. By being able to engage the side surfaces of the litter 16, the first and second linear outer rails 162, 164 can prevent the litter 16 from moving laterally off of the rail conveyor, and thereby falling off the ground and possibly injuring the patient therein.

The first linear conveyor section 94 also includes first and second guide members 170, 172 that, in a preferred embodiment, are generally tubular and are sized and configured for matingly engaging, and being disposed colinearly with the first and second guide members 130, 132 of the arcuate section 90. The first and second guide members 170, 172 define a guide receiving space 173 there between, for receiving a guide member, such as a fin 292, keel or stud, that can be designed to extend downwardly from the lower surface of the litter 16.

The first end 158 of the first linear section 174 includes mating members that include reduced diameter ends 176 of the outer rails 162, 164 and guide rails 170, 172 that are sized, positioned and configured for being received by the open tubular ends 126, 128 of the respective outer rails 114, 116 and inner rails 130, 132 of the first arcuate section 90. When properly assembled, the mating ends 176 are inserted into the open ends 126, 128. Additionally, the tongue member 150 that also comprises a part of the mating member positioned in a parallel plane with the tongue member 128 of the first arcuate section 90, so that the two can be disposed in a co-planar relationship with their apertures aligned so that the guide pin 134 can be inserted into their respective apertures to lock together the first arcuate section 190 and the first line section 94.

The mating member 178 at the second end 160 of the first linear section 94 comprises normal diameter sized hollow tubular ends 180 on each of the outer rail members 162, 164 and inner guide members 170, 172. A plurality of lateral ties 184 that are generally similar in size, shape and configuration to lateral ties 144, extend laterally between the various rail members 162, 164, 170, 172, to fixedly position the rail members 162, 164, 170, 172 with respect to each other and help to maintain their position.

A second linear conveyor section 98 includes a first end 188 that is sized and configured for mating to the second end 178 of the first linear section 94. The second linear conveyor 98 section also includes a second end 190 that is sized and positioned for mating to the first end of the third, reduced length linear section 100.

As the first 94 and second 98 linear sections arc generally identical, the same numbers that are employed on the first linear section 94 are also employed on the second linear section 98, it being understood that the similarly numbered parts are generally identical and serve generally identical functions. Depending upon the user's needs and desires, the length of the second linear section 98 can be the same or different as the length of the first linear section 94.

Relatively shortened linear conveyor section 106 is generally similar in configuration to the first and second longer linear conveyor sections 94, 98, except that it has a shortened length. The shortened modular section 100 includes a first end 196 and a second end 198, a first outer rail 200 and a second outer rail 202. The first and second outer rails 200, 202 are disposed in a spaced relation to define a litter 16 receiving space 204 there between. Additionally, as shown in FIG. 6, the outer rails 200, 202 are elevated so as to help capture the size of the basket 16 to help maintain the basket 16 on the litter receiving space 204.

The shortened modular section 106 also includes a guide member 208 that includes first and second spaced guard rails 210, 212. All of the rails 200, 202, 210, 212 extend in a generally parallel relation. However, the guard rails 210, 212 are disposed below the level of the outer rails 200, 202, and as such, do not engage the side surfaces of the litter basket 16. The first and second guard rails 210, 212 define a guide rail receiving space 214 there between that is sized and configured for receiving a male mating member 292 such as a stud, fin, or other lower depending member that can fit between the guide rails 210, 212 and in the space 214 to help maintain the litter basket 16 on the conveyor 12,

Mating members are provided at both ends of the conveyor section 100, and include reduced diameter portions 218 of the four rails 200, 202, 210, 212, that are sized for being interiorly received within the interior openings of the appropriate rails 162, 164, 170, 172 of the immediately preceding section, which is here shown as second linear section 98.

The tongue member 220 having an aperture (FIG. 7) is positioned to matingly engage a correspondingly positioned tongue 153 that is disposed at the second end 190 of the immediately preceding rail conveyor section, here shown as linear conveyor section 98. The mating member of the second end 198 of the shortened section includes normal diameter ends 228 of the guide rail members and normal open ends 224 of the outer rail member 200, 202.

It should be noted that the diameter is referred to as “normal diameter” generally have an outer diameter that is similar to the outer diameter of the remainder of the respective rails, and an inner diameter that is sized to be slightly larger than the outer diameter of the reduced diameter mating ends (e.g. 218), so that the normal diameter ends (e.g. 126, 180, 224) of the various sections can receive the reduced diameter ends (176, 218) of the immediately preceding section.

A tongue member 226 is disposed at the lower second end 198 and also forms is a part of the mating member, as the tongue member 226 includes an aperture for receiving a pin, such as pin 134. Continuing onward with FIG. 4, it will be noted that a pin receiving aperture 231 is also included on tongue member 220.

The leg members 104, 106 are best shown in FIGS. 3 and 10 as each being identical in configuration. Each of the leg members 104, 106 includes a shaft portion 236 that has a reduced diameter relative to the diameter of the open second ends 224 oldie outer guide rail 200, 202 into which it will be inserted and interiorly received. The shaft portion 236 includes a first end 238 that is insertable into the guide rail and 224 and a second end 240. A longitudinal array of spaced pin-receiving apertures 244 are formed along the shaft portion 236 and designed for receiving a pin, that, as shown in FIG. 4 is insertable through a pin receiving aperture 230 of guide rails 200, 202, and also through the pin receiving apertures 244, to interlock the leg 104, 106 and the guide rails 200, 204.

It will be noted that the two leg members 104, 106 are received by different outer rails, and are independently adjustable. For example, the first leg 104 can be inserted into outer rail 200, to a point wherein the pin 134 is extended through the aperture 241 that is disposed closest to the foot member. At the same time, the pin 134 can be extended through the aperture 243 that is disposed closest in the first end of leg 106 that is received into outer rail 202. As will be appreciated, this provides independent adjustability of the first and second 104, 106 legs.

This adjustability is employed so that one can compensate for different distances between the lower end 198 of the conveyor section 100 and the second elevation, such as the ground to which it engages. It will be appreciated that this distance will differ from time to time and based on differences in equipment, level of the ground, and elevational differences.

In most cases, the first and second legs 104, 106 will be adjusted so that they extend outwardly from the second end 198 of the rail section 100 at the same distance. However, on certain hill type situations, the first leg 104 should be extended out for a greater distance than the second leg 106, or vise versa. The independent adjustability of the two legs 104, 106 helps to increase the performance of this device, for on a hill, the two legs can be adjusted so that each can engage the ground securely, even though the slope of the ground wherein the legs 104, 106 engage the ground 22, varies between the first and second legs 104, 106.

Each of the first and second legs 104, 106 includes a foot member 206 that has a ground engaging bottom surface 248. A pivot pin 252 is provided for pivotably coupling the foot member 246 to the second end 240 of the leg. Another degree of adjustability can be obtained by choosing whether to engage the ground with the ground engaging surface 248, or else an end, such as end 251.

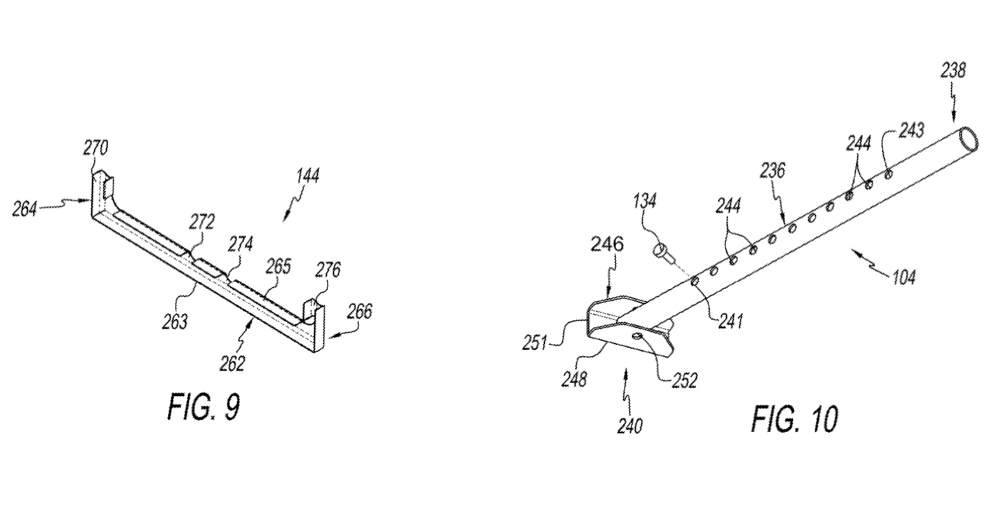

A typical laterally extending tie member 144 is shown in FIG. 9. The tie member 144 extends between and supports the various rails, such as the first and second outer rails and the first and second guide rails. The laterally extending tie 144 and includes a laterally extending portion 262 that has a lower surface 263 and an upper surface 265. First and second upright portions 264, 266 extend parallel to each other and generally perpendicular to the laterally extending portion 262. The first and second upright portions 262, 266 are disposed at either end of the lateral portion 262.

The upper surface 265 of the laterally extending tie includes a first concave saddle surface 272 for receiving the first guide member, and a second space concave saddle surface 274 for receiving the second guide member. The first upright portion 262 includes an outer rail receiving surface 270 for receiving the first outer rail, and a second upright portion includes a second outer rail receiving surface 276 for receiving the second outer rail.

It will be noted that the first and second upright portions 264, 266 are raised relative to the guide member receiving portions 272, 274, which results in the first and second outer rails (e.g. 200, 202) being relatively elevated relative to the guide members (e.g. 210, 212). Preferably, the first and second upright portions 264, 266 elevate the outer rails 200, 202 to a position where the outer rails 00, 202 are capable of engaging the side surfaces of the basket 16.

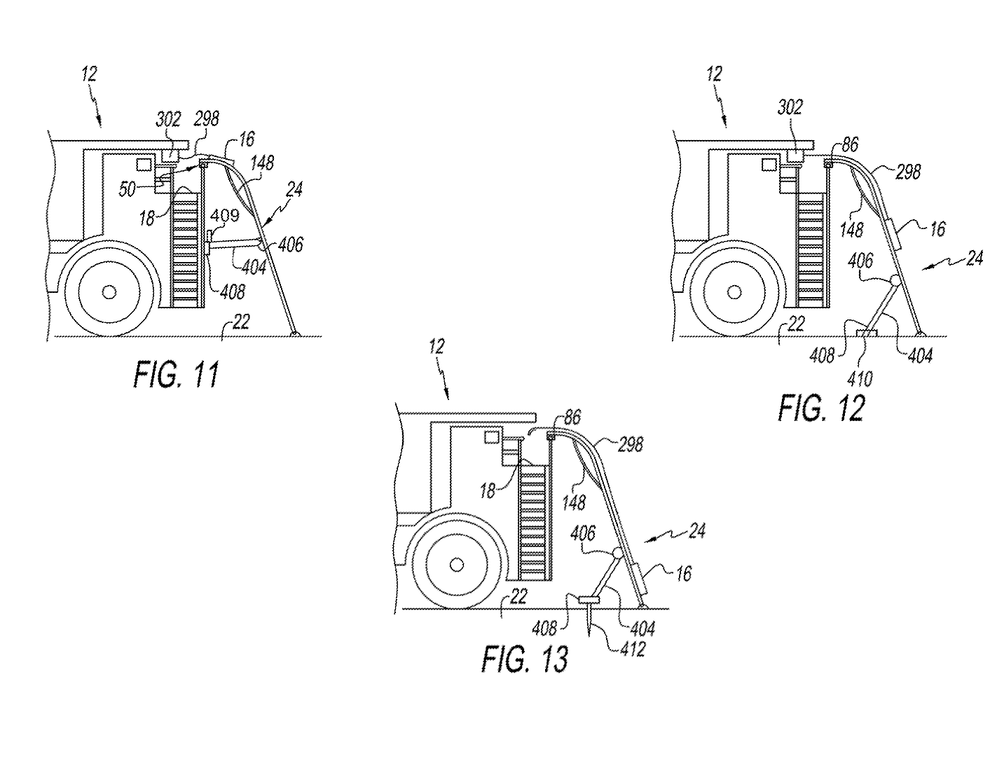

Turning now to FIGS. 11-15, the basket system 16 for use with the present invention is shown. The basket shown comprises a modified Stokes basket, that generally includes a wire frame basket that provides a device sturdy enough to hold a body while using the wire to reduce weight. The Stokes basket includes a base portion 286, a side portion 288, an upper rail 290 and a pair of end portions 291.

The Stokes basket 16 is sized and shaped to receive a normal shaped body, and maintain the body within the interior of the basket 16. The side portion 288 of the Stokes basket 16 helps to maintain the body within the interior of the Stokes basket 16, and keep the body from falling out.

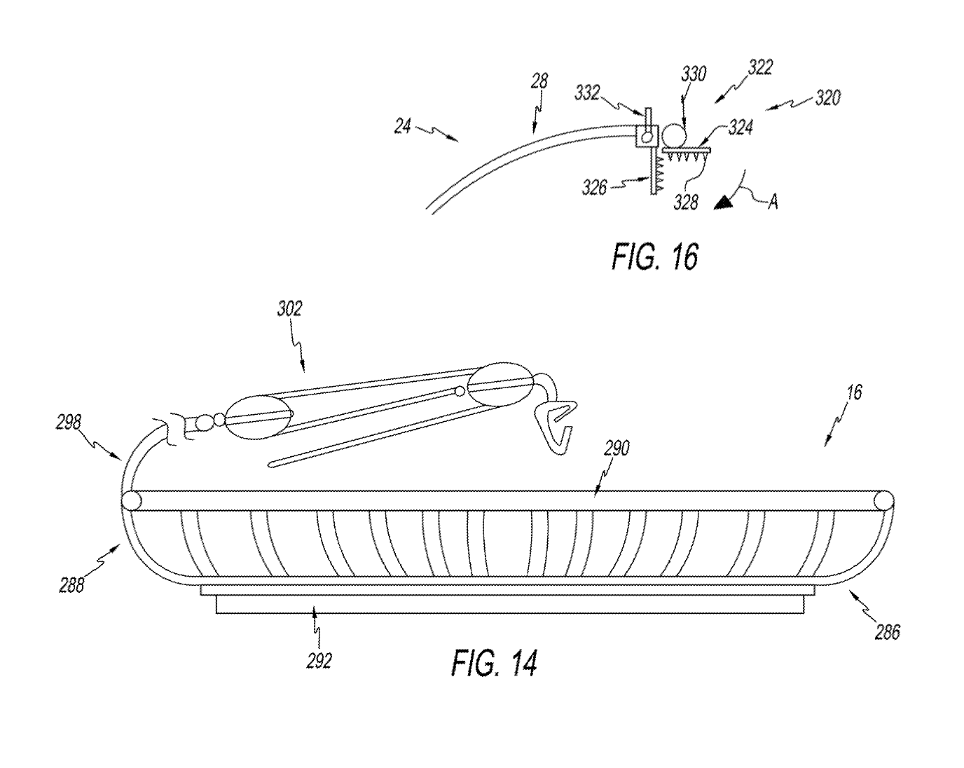

A male guide member 292 that may comprise a fin or keel like structure such as shown at FIG. 14, or otherwise may comprise a stud or the like extends along the longitudinal axis of the basket 60. The guide member 292 is sized and shaped to be configured to be received in the guide receiving space 134 (FIG. 15) to help maintain the appropriate lateral position of the Stokes basket 16 on the conveyor track 24 and to help prevent the Stokes basket 16 from moving laterally off the track.

A rope member 298 is coupled to the end of the Stokes basket 16 to enable the rescuers to raise and lower the stokes basket along the surface of the conveyor 24, as shown in progressive views 11, 12, and 13. A rope assist mechanism, such as a block and tackle 302 that provides a mechanical advantage to the user or a belaying mechanism, that provides a “brake” to the rope movement, can be provided to facilitate the movement of the basket 16 along the conveyor 24. As shown best in FIGS. 11-13, the basket 16 is placed on the first end portion of the conveyor 24 and the rope 298 is coupled to the rope assist mechanism 302, which itself may be firmly anchored to a secure anchoring point, such as a secure eyelet on the vehicle.

The rope 298 is played out, to allow the basket 16 to move past the transition point, so that its generally horizontal orientation, when at the first end, FIG. 11 becomes a more vertical orientation as the basket 16 moves down the conveyor 24. The rope 298 continues to be played out until the basket 16 is disposed adjacent to the ground 22, at which point the basket 16 can be lifted by the rescuers, and transported to an appropriate ambulance or medical care facility.

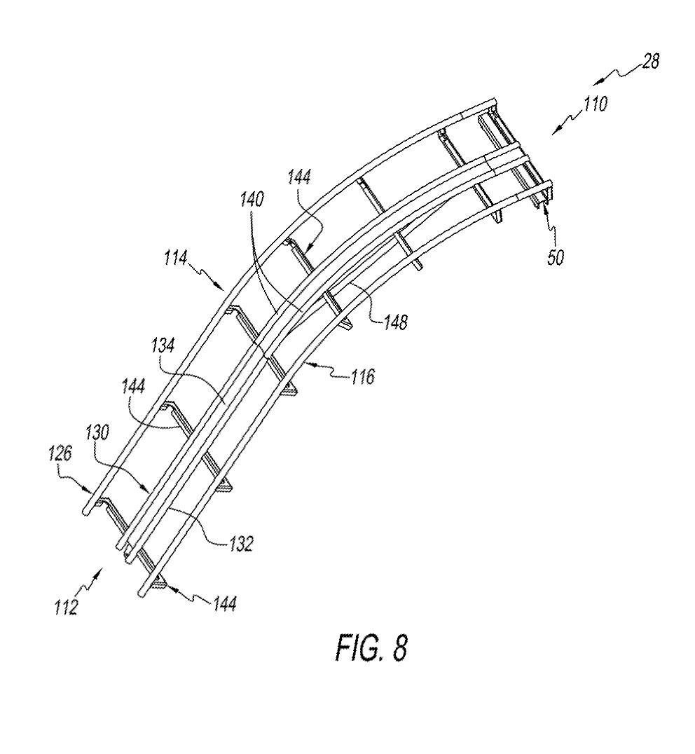

A plurality of other types of couplers exist that can be employed in place of the coupler 50 that is shown in FIGS. 1 and 8. These couplers are best shown in FIG. 16-22.

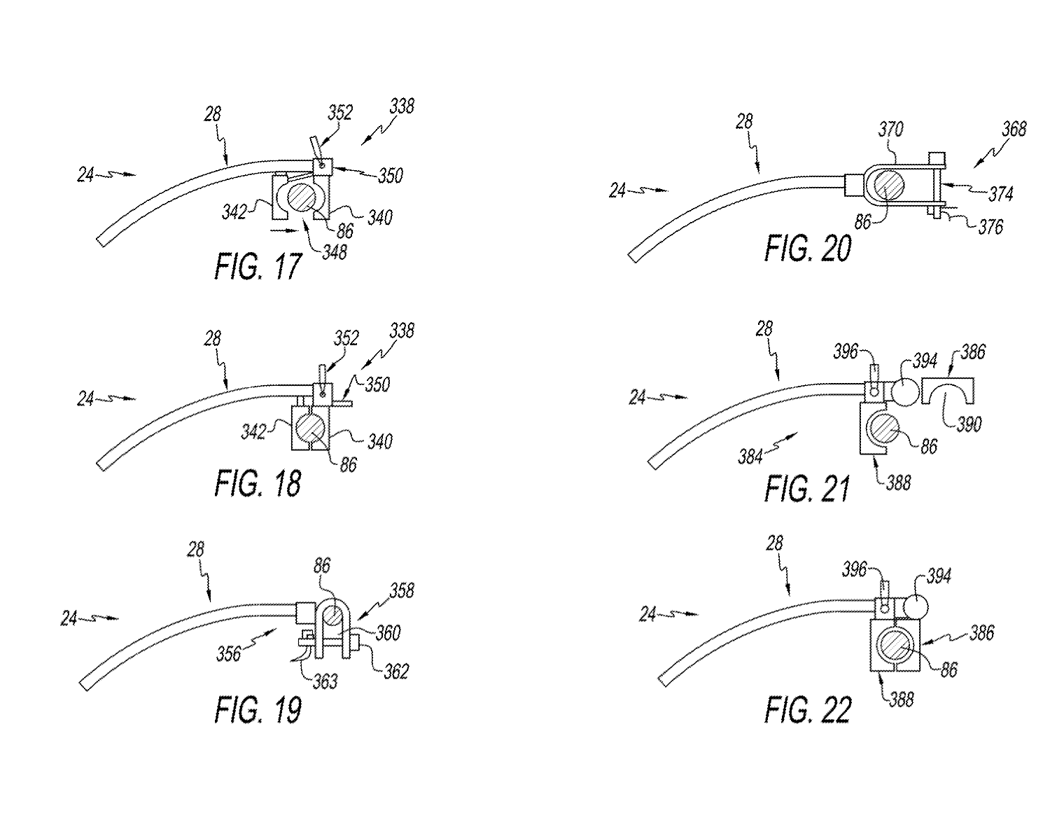

The first alternate embodiment coupler 322 is not designed for coupling to a rail 86, as are the couplers shown in FIG. 17-22. Rather, the coupler 322 is shown as being coupled to a step-like surface, such as a step on a heavy equipment device, or to the edge of a pit, if the conveyor 24 is descending into a pit. The coupler 322 includes a first jaw member 324, that is rotatably movable about arrow A between an open position such as shown in FIG. 16, and a closed position. In the closed position, the first jaw member 324 engages the second jaw member 326 with the tube being disposed in a generally parallel relationship. When the coupler 322 is being used to engage this step, it is envisioned that the coupler will have the two jaws 324, 326 disposed generally perpendicular to each other.

A ratchet member 330 is provided that serves as a lock so that the relative position of the first jaw member 324 and second jaw member can be fixed at a plurality of positions between their completely open and closed position. In this regard, the ratchet member works similarly to the ratchet on a conventional seat belt or a air of hand cuffs, insofar as the ratchet mechanism will allow the jaws to move in a first direction (generally the direction shown in FIG. A), but will not allow the jaws to move in an opposite direction without the release handle 332 being actuated to release the locking ratchet mechanism.

A second coupler 338 is shown in FIGS. 17 and 18. FIG. 17 shows the coupler 338 in the open position, and FIG. 18 shows the coupler 338 in the closed position. The coupler 338 includes a first jaw member 340 that is generally fixedly positioned, and a second jaw member 342 that is moveable with respect to jaw 340 between an open position as shown in FIG. 17 and a closed position shown in FIG. 18. The first and second jaws 340, 342 define an opening 348 for receiving the anchoring member, here shown as the rail 86 of the heavy equipment device 12. A ratchet mechanism 350 having a release member 352 serves to lock the relative position of the jaws 340, 342 to thereby maintain the rail member 86 within the opening 348 of the jaws.

The third alternate embodiment coupler is shown in FIG. 18. Coupler 356 is shown in FIG. 19 as including a generally “U” shaped yoke 358 that defines an opening 360 for receiving the anchoring member 86, which here is shown as hand rail 86. A locking pin 362 extends between the jaws of the yoke 358 to block the opening to the yoke 358. A cotter pin 363 is provided for maintaining the locking pin 362 within the yoke 358.

A fourth coupler embodiment 368 is shown in FIG. 20. Fourth coupler 368 is generally similar to yoke type coupler 356 except with regard to the orientation of the “U” shaped member 370. The “U” shaped member 370 defines an opening 372 for receiving the rail member 86. A locking pin 374 extends between the jaws of the “U” shaped yoke 370, and includes a cotter pin 376 for maintaining the locking pin 374 in its proper position in the “U” shaped member.

Locking mechanisms other than a locking pin and cotter pin can be employed. Several examples of such shackle and locking mechanisms that might be useable with the current invention include modern halyard shackles used on contemporary sailboats along with screw shackles and moving head shackles sold by a variety of sources.

The fifth coupler 384 is shown in FIGS. 21 and 22. In FIG. 21, the fifth coupler 384 is shown in its opened position, and in FIG. 22 it 384 is shown in its closed position.

The fifth coupler 384 includes a first jaw member 386 that is rotatably moveable with respect to the second or static jaw 388, about a pivot point defined by ratchet member 394. The first and second jaw members 386, 388 define an opening 390 for receiving a railing member 18. The ratchet member 394 permits the jaw 386 to move in a closing direction, as shown by arrow A, between the open and closed position, but prevents movement in a counter clockwise (or unlocking) position due to the one-way nature ratchets. When the jaw 386 is moved into engagement with the jaw 388, the ratchet will maintain the two jaws in a closed position, until such time as the release member 396 releases the ratchet mechanism to allow the jaw 386 to move from its closed position (FIG. 22) to its open position (FIG. 21).

Returning now to FIGS. 11-13, an optional support brace member 404 is shown. Support brace 404 is provided to help to impart additional structural rigidity to the conveyor 24, and to better help maintain the conveyor 24 in its appropriate position. The optional support brace 404 includes a telescopic shaft member of variable length that includes a first end 406 that is coupled to the conveyor 24, and a second end 408 that can be coupled either to the ground (FIGS. 12 and 13) or to the equipment member (FIG. 11). A variety of couplers can be employed to couple the support brace appropriately. For example, a rotatable coupler can be used to couple the first end 406 to the conveyor 24, so that one can vary the angle of the support brace 404 to an appropriate angle. A frame anchor member 409 can be attached to the second end 408 of the brace 404 to securely attached the second end 408 of the brace to the vehicle unit 12, or east some hard point on the vehicle member 12.

In FIG. 12, a foot member 410 is shown as being pivotably coupled to the second end 408 of the support brace 404, in much the same manner as the foot 246 is coupled to the lower end of leg 104 in FIG. 3. In FIG. 13, the second end 408 of brace 404 is coupled to a spike 412 that is driven into the earth at the second elevation 22. The spike 412 can include an eyelet for receiving a hook or coupler that is coupled to the second end 408 of the support brace 404.

Having described the invention in reference to certain detailed descriptions, it will be appreciated that variations and modifications exist within the scope and spirit of the present invention as defined in the claims set forth herein to below.

What is claimed is:

1. A patient transport conveyer for conveying a patient on a litter between a first elevation, and a second elevation, the transport conveyor comprising:
a rail containing conveyor having a first end for placement at the first elevation and a second end for placement at the second elevation, the rail containing conveyer including:
first and second spaced generally parallel rail members extending generally between the first and second ends, the first and second rail members defining a litter receiving space for receiving the litter and maintaining the litter on the conveyor,
a guide member extending generally between the first and second ends, the guide member being configured for being engaged with the litter to help maintain the litter in the litter receiving space, and
a coupler disposed at the first end and configured for coupling the transport conveyor to an anchoring at the first elevation for maintaining the position of the transport conveyor.

2. The patient transport conveyor of claim 1 wherein the first and second parallel rail members include an arcuate portion for enabling the user to change the pitch of the litter as it moves between the first and second ends.

2. The patient transport conveyor of claim 2 wherein the rail conveyor includes at least a first conveyor module and a separate second conveyor module, the first conveyor module including a first mating member and the second conveyor includes a second mating member configured for mating to the first mating member for removably coupling the first conveyor module to the second conveyor module.

4. The patient transport conveyor of claim 3 where n the first mating member is coupled to at least one of the first and second rail members of the first conveyor module, and the second mounting member is coupled to at least one of the first and second rail members of the second module, wherein the first and second mating member align and join the first and second rail member of the first conveyor module to the first and second rail member of the second conveyor module.

5. The patient transport conveyor of claim 4 further comprising a lock member for locking together the first conveyor module and second conveyor module.

6. The patient transport conveyor of claim 5 wherein the lock member includes a first axially extending tongue including a first aperture and being coupled to the first conveyor module, a second axially extending tongue including a second aperture and being coupled to the second conveyor module, and a pin member configured for insertion in the first and second apertures for locking together the first and second modules.

7. The patient transport conveyor of claim 1 wherein the first and second spaced parallel rail members are spaced sufficiently for defining a litter receiving space there between, and are positioned for engaging side surfaces of the litter for maintaining the litter in the litter receiving space between the first and second generally parallel rail members.

8. The patient transport conveyor of claim 1 wherein the guide member includes a male guide member coupled to one of the rail containing conveyor and the litter, and a female guide member coupled to the other of the rail containing conveyor and litter, the female guide member being configured for receiving the male guide member for guiding the litter between the first and second ends of the rail conveyor and maintaining the litter on the rail containing conveyor.

9. The transport conveyor of claim 8 wherein the female guide member comprises generally parallel first and second guide member rails coupled to one of the litter and rail containing conveyor, the first and second guide member rails defining a receiving slot there between and the male guide member is coupled to the other of the litter and rail containing conveyor, and is configured for being received in the receiving slot.

10. The transport conveyor of claim 9 wherein the first and second guide member rails are coupled to the rail containing conveyor and extend generally parallel to the first and second generally parallel rail members, and wherein the male member comprises a fin like male member coupled to an underside of the litter.

11. The patient transport conveyor of claim 1 further comprising a first leg member coupled to the rail containing conveyor and having an axially variable length, and a second leg member coupled to the rail container conveyor in a spaced relation to the first leg member and having an axially variable length that is axially variable independently of the axial variability of the first leg member.

12. The patient transport conveyor of claim 11 wherein the first and second leg members include respective first and second ground engaging feet members pivotably coupled to the respective first and second leg members.

13. The patient transport conveyor of claim 11 wherin the first leg member comprises a generally tubular first leg member telescopically coupled to the rail conveyor adjacent to the second end of, and generally parallel to the first rail member, and the second leg member comprise a generally tubular second leg member telescopically coupled to the rail conveyor adjacent to the second end of and generally parallel to the second rail member.

14. The patient transport conveyor of claim 13 wherein the first tubular leg member includes a first end telescopically coupled to the rail conveyor and a second end, and the second tubular leg member includes a first end telescopically coupled to the rail conveyor and a second end, further comprising a first ground engaging foot member pivotably coupled to the second end of the first tubular leg member, and a second ground engaging foot member pivotably coupled to the second end of the second tubular leg member.

15. The patient transport conveyor of claim 1 wherein the coupler comprises a jaw member defining a jaw opening configured for receiving an anchoring.

16. The patient transport for conveying of claim 15 wherein the first elevation comprises an elevated component of a heavy equipment item, and the anchoring comprises a rail member of the heavy equipment item.

17. The patient transport conveyor of claim 14 wherein the coupler comprises a jaw member defining a jaw opening configured for receiving a tubular anchoring, and a lock member for closing the jaw opening for maintaining the tubular anchoring in the jaw opening.

18. The patient transport conveyor of claim 14 wherein the jaw member includes first and second jaw members, that define the jaw opening there between, and wherein the lock member comprises at least one pin member extending in the opening between the first and second jaw member.

19. The patient transport conveyor of claim 14 when the jaw member includes a first jaw member, and a second jaw member movable with respect to the first jaw member between an opened and closed position and a ratchet type lock mechanism for fixedly positioning the first jaw member with respect to the second jaw member.
